(19) United States
(12) Patent Application Publication
(10) Pub. No.: US 2023/0180665 A1
(43) Pub. Date: Jun. 15, 2023

(54) SYSTEMS AND METHODS FOR TEMPORARY CONVERSION OF A FLATBED TRAILER TO A BALE HAULER

(71) Applicant: Gore Cattle Company, LLC, Fairview Heights, IL (US)

(72) Inventor: Jim Gore, Fairview Heights, IL (US)

(21) Appl. No.: 17/962,359

(22) Filed: Oct. 7, 2022

Related U.S. Application Data
(60) Provisional application No. 63/253,360, filed on Oct. 7, 2021.

(51) Int. Cl. A01D 90/10

(52) U.S. Cl. CPC A01D 90/10

(57) ABSTRACT

A hay hauler which may be selectively attached to an removed from a flatbed trailer to allow the flatbed trailer to carry round hay bales. The hay hauler attachment may be configured and arranged to dump carried hay bales to the side of the flatbed trailer and may include a plurality of removable lift legs that, when attached, will serve to use the dumping motion to lift the hay hauler from the bed of the flatbed trailer.

### CROSS REFERENCE TO RELATED APPLICATION(S)

This Application claims the benefit of U.S. Provisional Patent Application 63/253,360 filed Oct. 7, 2021, the entire disclosure of which is herein incorporated by reference.

### BACKGROUND

### 1. Field of the Invention

There is described herein, among other things, a system and method for a conversion system that may provide a flatbed trailer with a hay bale-carrying system. Specifically, the hay bale-carrying system is repeatedly removable and allows for easy side dumping of the hay bales. Other objects may be carried by the hay bale hauling system, including other forms of bales.

### 2. Description of the Related Art

For as long as humans have maintained livestock and other ruminants or herbivores, they have needed to feed them. While grazing is the most common form of livestock feeding when available, seasonal changes in the accessibility of naturally occurring plants and the ability of a herd to graze or overgraze a particular area typically require livestock to either be moved to new pastures or to be fed some form of supplement during their lifetimes. Beef cattle, dairy cows, horses, goats, sheep, and other commercially important species typically need to be supplied plant matter by the humans who are managing them in order keep these animal alive during the winter or when they need to remain confined for management purposes. It can be a particular problem in winter (especially when snowfall is present) due at least to the seasonal unavailability of grasses and other vegetation.

For hundreds of years, supplementation of such animals has been performed through the use of hay. Hay is not necessarily a specific plant, but more of a form of plant matter. It is usually grass but can also be a legume (e.g., alfalfa) or other herbaceous plant. Hay is typically cut and dried during normal growing seasons. When dried, or even during drying, hay is often collected into a bale. The traditional bale was a large generally parallelepiped structure that is typically referred to as a “square bale”. A square bale was produced in modern agriculture with a baler, which was a machine designed to collect the hay material and compress it into the bale shape. That shape was then tied with string or wire to assist in in maintaining its shape, as well as to allow it to be easier to grab and carry.

Hay was compressed into bales primarily to allow a given bale to shed water. This water shedding ability prevent spoiling of the bales even when exposed to weather. Baling hay also allows for relatively compact storage. A single square bale readily weighs around 50 pounds, so the hay is quite compacted when it is formed. However, while the bale is heavy and a bit ungainly, it can be lifted and carried by hand. Traditionally, hay was baled into squares in the field and subsequently placed on a flatbed trailer where the square bales may be easily stacked for transport and storage.

U.S. Pat. No. 799,175, the entire disclosure of which is herein incorporated by reference, is believed to describe the first baler that produced a round bale. Round bales are not spherical, but are instead generally in the shape of cylinders. Round bales have an advantage over square bales because their shape allows them to more easily shed rainwater off their surface (when they are placed with their rounded surface upward) providing for less spoilage. While the baler in U.S. Pat. No. 799,175 is intended to produce fairly small bales, in recent years, round bales have generally taken over the hay industry, which is now dominated by large round bales. These bales can weigh 1500 pounds and include vastly more hay than smaller bales. Their larger size makes it easier to supply hay to larger herds of animals. Further, the large bales are easier to handle with a tractor than the equivalent small bales, allowing them to be loaded and transported by fewer workers.

Large round bales can still be stacked, but they can also roll. Because round bales can roll, trucks intending to convey a number of round bales must include structures to restrict the round bales from rolling to either side when laid on their round sides. Typically, this means that round bales are placed in a row on a specially made round bale truck or trailer. Such a specially made round bale truck or trailer will typically have a system along the sides of the bed that will retain the round bales. In some examples, the bed is designed to hold stacks of round bales, each stack having two round bales at the bottom with one round bale on top positioned somewhat between the two lower round bales. Because the lateral sides constrain the rolling of the round bales, these beds are typically designed to have the round bales removed from the bed by raising one end of the bed nearest to the cab of the related truck (or towards the truck pulling the trailer). This allows the round bales to be dumped from the rear of the truck bed where desired.

These prior art specially made round bale trucks and trailers have a number of drawbacks. First, such specially designed systems require a truck or a trailer that is relatively fixed in its use. Stated another way, such a system of handling round bales requires expensive and specialized equipment. This can be a major barrier for some smaller farming operations, where it can be impossible to invest significant capital into equipment with a single use. Another drawback of this type of round bale handling system is that the dump truck-like process for removing round bales from the bed may be inefficient. For example, dumping the bed of such a round bale handler may result in all of the bales being unloaded in a single area. Accordingly, it may not be possible to efficiently distribute bales in a field.

Moreover, dumping processes for prior hay carriers dumped the round bails out the back of the trailer or flatbed. This, however, may have the undesired consequence that the hay bales may land on their flat ends instead of on their curved sides. This may make subsequent movement of the round hay bales more difficult, as they cannot be easily rolled when on their flat side.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, there is a need for a system for conveying round hay bales that has improved efficiency and operation. Specifically, the systems may allow for the convertible use of a flatbed truck or trailer for the temporary conveyance of round hay bales. Further, the system may allow for efficient distribution of round hay bales by allowing for the selective dumping of the round hay bales.

There is described herein, in an embodiment, a hay hauler which may be selectively attached to an removed from a flatbed trailer to allow the flatbed trailer to carry round hay bales. The hay hauler attachment may be configured and arranged to dump carried hay bales to the side of the flatbed trailer and may include a plurality of removable lift legs that, when attached, will serve to use the dumping motion to lift the hay hauler from the bed of the flatbed trailer.

In an embodiment, there is described herein, a hay hauler attachment for a flatbed trailer, the attachment comprising: a frame configured to rest on the flatbed surface of a flatbed trailer; a hay bunk attached to said frame, said hay bunk having an elongated shape with a center support tube extending along the major dimension thereof and generally parallel to the direction of travel of said flatbed trailer, said hay bunk being further configured to engage a rounded side of a round hay bale and inhibit said round hay bale placed therein from rolling when said hay bunk is in a carrying position; and a dumping mechanism for rotating said hay bunk relative said center support tube from said carrying position to a dumping position where said round hay bale will roll from said hay bunk.

In an embodiment of the attachment, the hay bunk is generally U-shaped in cross section with said center support tube forming the lowest portion of said U.

In an embodiment of the attachment, the hay bunk is generally V-shaped in cross section with said center support tube forming the lowest point of said V.

In an embodiment, the attachment further comprises a second hay bunk attached to said frame , said second hay bunk also having an elongated shape with a center support tube extending along the major dimension thereof and generally parallel to the direction of travel of said flatbed trailer, said second hay bunk also being configured to engage a rounded side of a round hay bale placed therein and inhibit said round hay bale from rolling when said second hay bunk is in a carrying position; and a second dumping mechanism for rotating said second hay bunk relative said center support tube of said second hay bunk from said carrying position to a dumping position where said round hay bale will roll from said second hay bunk.

In an embodiment, the attachment further comprises a plurality of lift legs removeably attached to said hay bunk, wherein when said dumping mechanism rotates said hay bunk to said dumping positon, said lift legs engage the ground.

In an embodiment of the attachment, the lift legs lift said frame from said flatbed surface when said lift legs engage the ground.

In an embodiment of the attachment, the lift legs have an adjustable length.

### BRIEF DESCRIPTION OF THE DRAWINGS

FIG. 1 depicts a top view of a first embodiment of a hay hauler on a flatbed trailer.

FIG. 2 depicts a rear view of the embodiment of FIG. 1 with hay bunks in their upright or bale-carrying position.

FIG. 3 depicts a rear view of the embodiment of FIG. 1 with the hay bunks in their side or dump position.

FIG. 4 depicts a rear view of the embodiment of FIG. 1 with the hay bunks in their side or dump position with lift legs attached to lift the hay hauler off the flatbed trailer.

FIG. 5 depicts the top view of the embodiment of FIG. 1 showing specifics of a frame of the hay hauler and attachment to the flatbed trailer.

FIG. 6 depicts an embodiment of a bolt in liner suitable for use with the embodiment of the hay hauler of FIG. 1.

### DESCRIPTION OF PREFERRED EMBODIMENT(S)

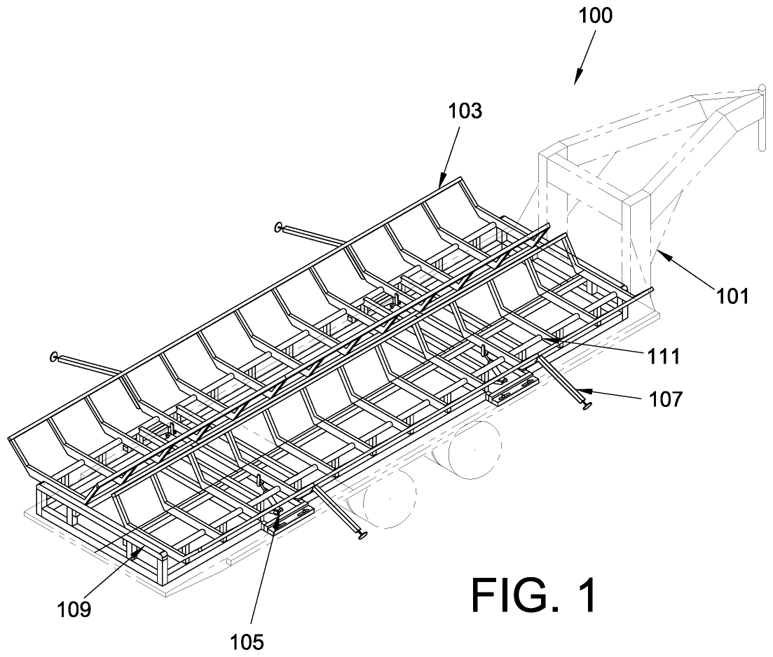

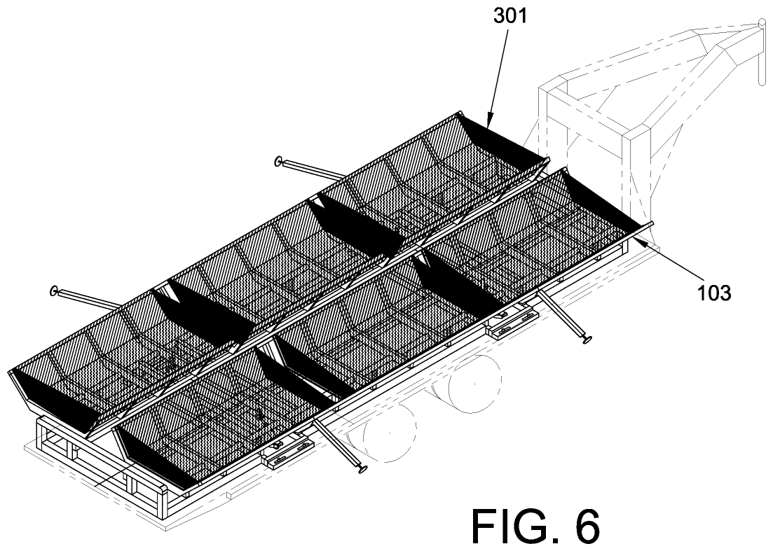

FIG. 1 depicts an embodiment of a hay hauler (100) as contemplated herein. In particular, a flatbed trailer (101) may be outfitted with a frame (109), the frame (109) supporting one or more hay bunks (103) and each hay bunk (103) having a center support tube (111). In other embodiments, the flatbed trailer (101) may be a flatbed of a truck, or any other relatively flat and mobile platform. Each hay bunk (103) may also be outfitted with a hydraulic cylinder (105), lift legs (107), and a liner (301) (shown in FIG. 6). In the depicted embodiment of FIG. 1, the frame (109) carries two separate hay bunks (103). Here, each hay bunk (103) may extend across the entire flatbed trailer (101). In other embodiments, a hay bunk (103) may extend beyond the flatbed trailer (101) or be shorter than the flatbed trailer (101). In yet other embodiments, a row of hay bunks (103) may be used to allow separate dumping for a given side of the hay hauler (100). In some embodiments, the hay bunks (103) may be modifiable so that the number, size, shape, configuration, or other feature may be changed at any given time to suit the user's needs.

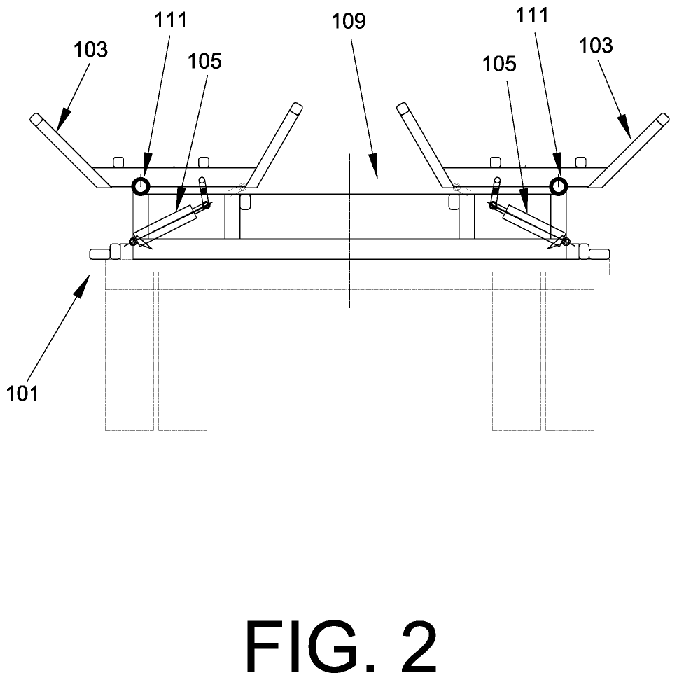

As shown in FIG. 2, each hay bunk (103) may have a generally “U” shape with the center support tube (111) being located at the valley of the “U” shape. In other embodiments, the hay bunks (103) may have any shape that sufficiently constrains a round hay bale when loaded into the hay bunk (103). For example, in some embodiments, the hay bunks (103) may have a generally “V” shape with the center support tube (111) being located at the valley of the “V” shape. In yet other embodiments, the generally “U” shape or “V” shape may be modified in some respect, as would be understood by persons of ordinary skill in the art. In addition, and as will be discussed more below, any shape for a given hay bunk (103) will also need to accommodate the process of rotating the hay bunk (103) about 90 degrees along the center support tube (111) to allow for the removal of a given hay bale mounted on the hay bunk (103) being rotated. In some embodiments, two hay bunks (103), or two rows of hay bunks (103), may be mounted side by side on the frame (109). This may allow for the stacking and distribution of round hay bales from either side of the hay hauler (100). In the depicted embodiment, each hay bunk (103) is arranged to extend length-wise in the direction of travel for the flatbed trailer (101). In other embodiments, other arrangements of hay bunks (103) may be used. For example, in an embodiment, a single hay bunk (103) may extend length-wise on a flatbed trailer (101). In yet other embodiments, any number of hay bunks (103) may be arranged end to end along the length of the flatbed trailer (101). For example, the embodiment depicted in FIG. 1 may include two rows of two hay bunks (103) wherein either side of the flatbed trailer (101) may include more than one hay bunk (103) arranged in a row, as briefly described above. Again, this row-based configuration may allow for each side to make multiple, independent dumps of round hay bales.

For the hay hauler (100), the flatbed trailer (101) acts as a primary support platform, which platform serves as a base for all of the other components. In the depicted embodiment of FIG. 1, a frame (109) is used to connect the major portions of the hay hauler (100) to the flatbed trailer (101).

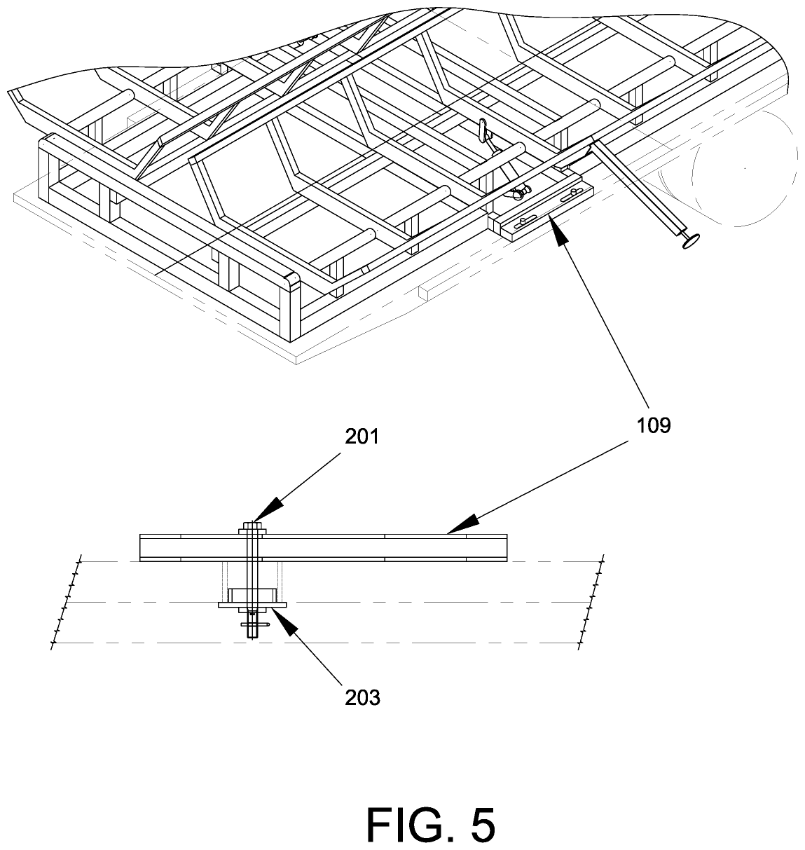

FIG. 5 shows an embodiment of a fastening system for attaching the frame (109) to the flatbed trailer (101). In the depicted embodiment shown in FIG. 5, the fastening system includes a fastener (201) and a washer or pad (203). Typically, this fastening system will be removable by someone in the field while also providing sufficient fastening such that the hay hauler (100) can be operated without the frame (109) falling off of or otherwise moving relative to the flatbed trailer (101). In other embodiments, other fastening systems may be used, as would be understood by a person of ordinary skill in the art. Each hay bunk (103) may be attached to the frame (109). This bunk/frame attachment may be accomplished by any means but will typically be achieved by a system that allows the center support tube (111) of each hay bunk (103) to rotate freely. For example, brackets may be mounted to the frame (109) that have a means of fixing the bracket to the center support tube (111) in a freely moving configuration. As would be understood by a person with ordinary skill in the art, a friction-reducing system may be implemented to allow the center support tube (111) to freely rotate within the bracket while still allowing the bracket to support the load of the hay bunks (103). The center support tube (111) is typically fixed to a given hay bunk (103) in a manner that does not allow rotation. In this way, the center support tube (111) may serve as an axis of rotation for each hay bunk (103).

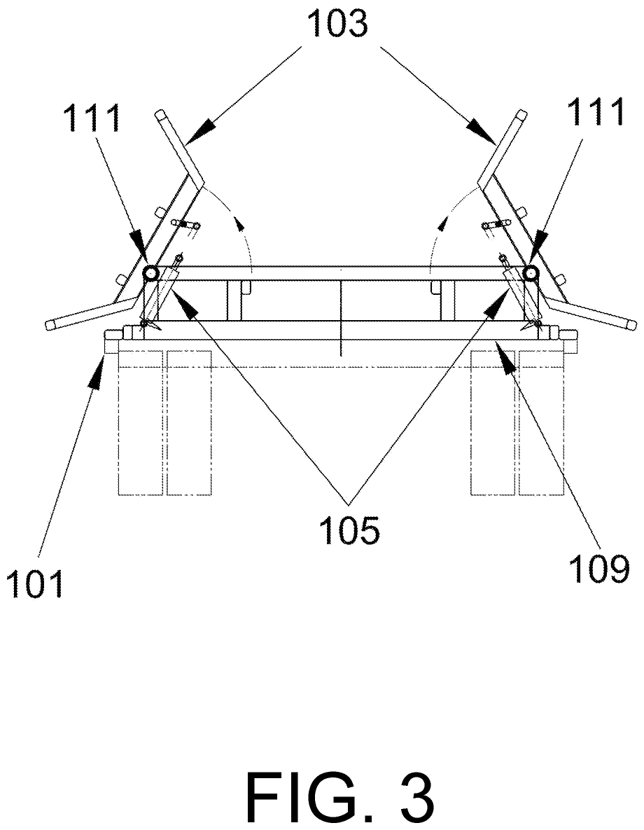

Rotation of each hay bunk is illustrated in the differences between FIGS. 2 and 3. FIG. 2 shows a rear view of an embodiment of a hay hauler (100). In FIG. 2, two hay bunks (103) are shown, each being in their upright or bale-carrying position. In this position, each hay bunk (103) has its “U” shape oriented such that the “U” is open in the vertical direction. This configuration may allow a round hay bale to sit within the “U” shape, thereby constraining any side to side rolling of the round hay bale. Essentially, gravity and the shape of the hay bunk (103) will keep a large round hay bail in place. In other embodiments, other shapes for the hay bunks (103) may be used as long as they assist in retaining round hay bales, as discussed above.

In this upright or bale-carrying position, the round bales resting in the hay bunks (103) will be relatively secure. Further, this position for each hay bunk (103) is typically relatively secure, and the hay bunk (103) itself will not rotate under the weight of the round hay bales. When intended, the hay bunks (103) may be rotated such that the “U” shapes of each hay bunk (103) faces outward from the flatbed trailer (101) in a horizontal direction, typically in opposite directions from each other when two hay bunks (103) are used. FIG. 3 depicts a rear view of the embodiment of the hay hauler (100) with the hay bunks (103) being in their side or dump position. This position allows gravity to assist in removing the round bales from each of the hay bunks (103). As stated above, each hay bunk (103) may be operated independently. In other embodiments, the operation of two or more hay bunks (103) may be linked. Further, because the hay bales may be carried lengthwise in the hay bunks (103), and dumped from the side, the hay bales will typically land on their rounded sides, unlike how the hay bales tend to land on their flat ends after prior art dumps.

In the depicted embodiments of FIGS. 2 and 3, each hay bunk (103) is provided with one or more hydraulic cylinders (105) that may assist in the tipping process. For example, in FIG. 2, two hydraulic cylinders (105), one for each hay bunk (103), is in an extended position. This extended position allows for the hay bunks (103) to be in their upright or bale-carrying position. Next, in FIG. 3, each hydraulic cylinder (105) is in a shortened position, which position has brought the hay bunks (103) into their side or dump positions. In other embodiments, the operation of the hydraulic cylinders (105) may be different, as would be understood by a person with ordinary skill in the art. Further, more than one hydraulic cylinder (105) may be used per hay bunk (103). For example, as depicted in FIG. 1, each hay bunk (103) includes three hydraulic cylinders (105). In other embodiments, other methods of assisting with the rotation of the hay bunks (103) may be used instead of or in addition to the hydraulic cylinders (105).

As discussed above, one of the advantages of the hay hauler (100) disclosed herein is that the flatbed trailer (101) may be separated from the other portions of the hay hauler (100). As shown in FIG. 1, a plurality of lift legs (107) may be removeably attached to each hay bunk (103). In the depicted embodiment, each hay bunk (103) has two lift legs (107) attached to upper portions of each hay bunk (103). More or less lift legs (107) may be used, and each leg may be attached to the hay hauler (100) in other ways or at other points. The attachment of the lift legs (107) will typically only be carried out when there are no hay bales in the hay bunk (103) so that the lift legs (107) do not interfere with placing hay bales in the hay bunks (103). However, in a an alternative embodiment, the lift legs (107) may be permanently attached to the hay bunks (103).

Typically, to remove the other portions of hay hauler (100) from the flatbed trailer (101), the lift legs (107) will be installed onto the hay bunks (103) when such removal is desired which will often occur when the hay bale carrying capacity of the flatbed trailer (101) is not needed and the flatbed trailer (101) is being converted back to it's standard purpose of acting as a flat bed for carrying other items. Once the lift legs (107) are installed on the hay bunks (103), the hay bunks (103) may be rotated to their side or dumping position using the same methodologies and systems discussed above for dumping hay bales. In this position, the lift legs (107) may be oriented substantially vertically, or otherwise oriented in an manner that will allow for the hay hauler (100) to stand independently once removed from the flatbed trailer (101).

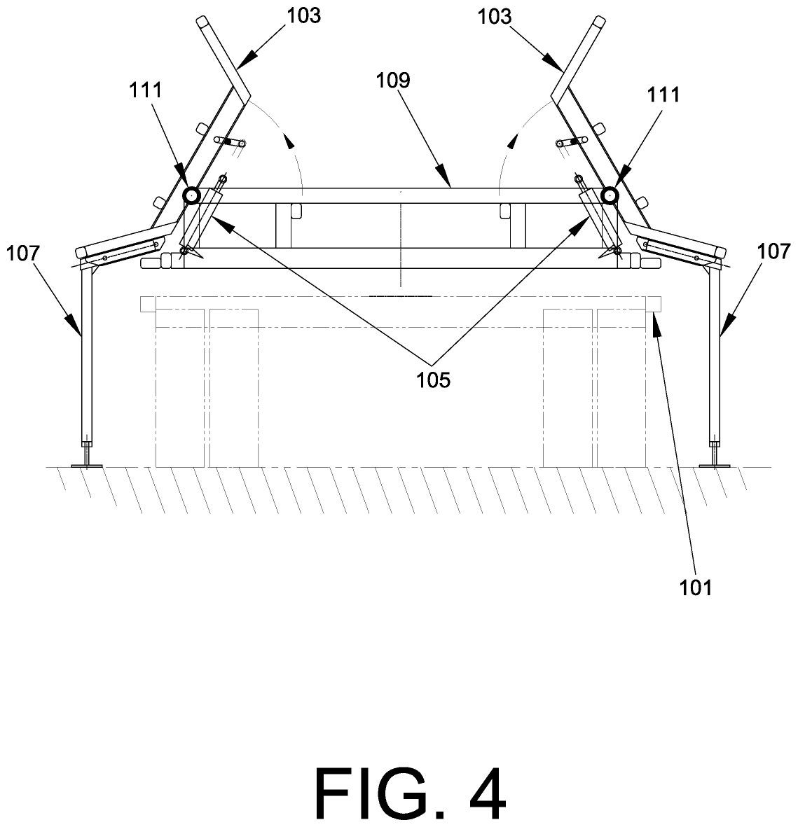

In order to position the lift legs (107) substantially vertically, or in a standing position where the end result is not a vertical orientation of the lift legs (107), the one or more hydraulic cylinders (105) may be used to move the hay bunks (103) into their sideways or dumping position. As shown in FIG. 4, each hydraulic cylinder (105) may be moved into a shortened position, which position may bring the hay bunks (103) into their side or dump positions. During this change in position, the lift legs (107) may be brought into contact with the ground. In some embodiments, the hydraulic cylinders (105) may be used to continue to rotate the hay bunks (103) past the point where the lift legs (107) first touch the ground, which further movement may lift the frame (109) off of and above the top of the flatbed trailer (101).

In some embodiments of the hay hauler (100), the lengths of the lift legs (107) may be extended or retracted to adjust their length, which may affect the freestanding height of the frame (109) when removed from the flatbed trailer (101). Further, in any embodiment, any means of lifting the hay hauler (100) may be used, such as the use of a jack-like extending functionality within the lift legs (107). More typically, the lift legs (107) may be hydraulically operated or assisted, either on their own (by altering their length) or by rotating the hay bunks (103) or some other means as would be understood by persons of ordinary skill in the art.

Of course, all fasteners between the flatbed trailer (101) and the frame (109) must first be removed before any separation may be made, regardless of the lifting technique. Once a sufficient gap is established between the flatbed trailer (101) and the frame (109), the flatbed trailer (101) can simply be moved from under the remainder of the hay hauler (100). The remainder of the hay hauler (100) may then remain in this position until needed again. From this separated position, the hay hauler (100) may be lowered onto a different flatbed trailer (101), the same flatbed trailer (101), or a different object (such as, but not limited to the bed of a truck, a different form of trailer, or even a specialized wheel unit) for transport and/or storage. This ability of the hay hauler (100) may allow for the related flatbed trailer (101) to be used for other purposes while the hay hauler (100) is not needed to haul hay or otherwise.

In some embodiments, it may be desired for the hay bunks (103) to be used as containers for dumping objects other than hay bales. For example, a user of the hay hauler (100) may desire to convey a large amount of rocks in order to create a road. In this case, each hay bunk (103) may be outfitted with a liner (301). In some embodiments, the liner (301) may be rigid. In other embodiments, the liner (301) may be flexible. In any case, the liner (301) may be affixed to a hay bunk (103) using any fastening means. For example, in some embodiments, the hay hauler (100) may use bolts to attached the liner (301) to a given hay bunk (103). Again, this may allow each hay bunk (103) to be loaded with materials such as rock, dirt, lime, or the like. In such an embodiment, the hay hauler (100) may then be used as a “dump truck” using the hydraulic cylinders (105) to dump the contents of the hay bunk (103) when desired.

Each of the components of the hay hauler (100) may be made from any material capable of withstanding the stresses (physical, environmental, and the like) anticipated to be placed on the components. In many embodiments, the vast majority of the components will be made from weather resistant metal materials. Further, the sizes and shapes of the various components of the hay hauler (100) may vary as long as the components remain capable of performing their various functions.

While the invention has been disclosed in conjunction with a description of certain embodiments, including those that are currently believed to be useful embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “U Shaped” are purely geometric constructs and no real-world component or relationship is truly “U Shaped” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

1. A hay hauler attachment for a flatbed trailer, the attachment comprising:
a frame configured to rest on the flatbed surface of a flatbed trailer;
a hay bunk attached to said frame, said hay bunk having an elongated shape with a center support tube extending along the major dimension thereof and generally parallel to the direction of travel of said flatbed trailer, said hay bunk being further configured to engage a rounded side of a round hay bale and inhibit said round hay bale placed therein from rolling when said hay bunk is in a carrying position; and
a dumping mechanism for rotating said hay bunk relative said center support tube from said carrying position to a dumping position where said round hay bale will roll from said hay bunk.

2. The attachment of claim 1 wherein said hay bunk is generally U-shaped in cross section with said center support tube forming the lowest portion of said U.

3. The attachment of claim 1 wherein said hay bunk is generally V-shaped in cross section with said center support tube forming the lowest point of said V.

4. The attachment of claim 1 further comprising:
A second hay bunk attached to said frame , said second hay bunk also having an elongated shape with a center support tube extending along the major dimension thereof and generally parallel to the direction of travel of said flatbed trailer, said second hay bunk also being configured to engage a rounded side of a round hay bale placed therein and inhibit said round hay bale from rolling when said second hay bunk is in a carrying position; and
a second dumping mechanism for rotating said second hay bunk relative said center support tube of said second hay bunk from said carrying position to a dumping position where said round hay bale will roll from said second hay bunk.

5. The attachment of claim 1 further comprising:
a plurality of lift legs removeably attached to said hay bunk, wherein when said dumping mechanism rotates said hay bunk to said dumping positon, said lift legs engage the ground.

6. The attachment of claim 5 wherein said lift legs lift said frame from said flatbed surface when said lift legs engage the ground.

7. The attachment of claim 5 wherein said lift legs have an adjustable length.
